(19) United States
(12) Patent Application Publication
(10) Pub. No.: US 2014/0261841 A1
(43) Pub. Date: Sep. 18, 2014

(54) KINK RESISTANT HOSE SYSTEM WITH COIL LAYER AND METHOD OF MANUFACTURING

(71) Applicants: Robert Bosch GmbH, Stuttgart (DE); Robert Bosch Tool Corporation, Broadview, IL (US)

(72) Inventors: Timothy J. Orow, Peoria, IL (US); Lawrence P. Heren, East Peoria, IL (US)

(73) Assignees: Robert Bosch GmbH, Stuttgart (DE); Robert Bosch Tool Corporation, Broadview, IL (US)

(21) Appl. No.: 14/201,991

(22) Filed: Mar. 10, 2014

Related U.S. Application Data
(60) Provisional application No. 61/785,261, filed on Mar. 14, 2013.

(51) Int. Cl. F16L 11/08; B29D 23/00

(52) U.S. Cl. CPC F16L 11/08; B29D 23/001
USPC 138/118; 264/280; 264/400; 264/209.2; 156/187; 83/54

(57) ABSTRACT

A fluid conduit includes a flexible member having a tubular wall for conveying a fluid and a circumferential structural member positioned adjacent to the tubular wall. The structural member is disposed about a central axis of the conduit so as to form a plurality of spaced segments along the wall. The segments are spaced apart relative to each other to define a gap therebetween. The gap is sized to be closed by contact between adjacent segments upon a predetermined flexure of the flexible member. A method of forming the fluid conduit includes forming a flexible member with a tubular wall and forming a groove about a central axis of the conduit in a portion of the tubular wall. The groove is formed by removing material from the tubular wall or compressing material on the tubular wall.

This application claims the benefit of U.S. Provisional Application No. 61/785,261, filed Mar. 14, 2013, the disclosure of which is incorporated herein by reference in its entirety.

### FIELD OF THE INVENTION

The present disclosure relates to fluid conduits and, more particularly, to flexible hoses.

### BACKGROUND

Flexible hoses are widely utilized in a wide variety of industrial, household, and commercial applications. One commercial application for hoses are garden or water hoses for household or industrial use. For instance, the hoses are used for watering grass, trees, shrubs, flowers, vegetable plants, vines, and other types of vegetation, cleaning houses, buildings, boats, equipment, vehicles, animals, or transfer between a fluid source and an appliance. For example, the appliance can be a wash stand, a faucet or the like for feeding cold or hot water. Another commercial application for hoses are automotive hose for fuel delivery, gasoline, and other petroleum-based products. Another application for hoses are vacuum cleaner hoses for household or commercial applications. For instance, the hoses are used with vacuum cleaners, power tools, or other devices for collecting debris or dispensing air. Fluids, such as beverages, fuels, liquid chemicals, fluid food products, gases and air are also frequently delivered from one location to another through a flexible hose.

Flexible hoses have been manufactured for decades out of polymeric materials such as natural rubbers, synthetic rubbers, thermoplastic elastomers, and plasticized thermoplastic materials. Conventional flexible hoses commonly have a layered construction that includes an inner tubular conduit, a spiraled, braided, or knitted reinforcement wrapped about the tubular conduit, and an outer cover.

Kinking and collapsing are problems that are often associated with flexible hoses. Kinking occurs, for example, when the hose is doubled over or twisted. A consequence of kinking is that the flow of fluid through the hose is either severely restricted or completely blocked. Kinking becomes a nuisance and causes a user undue burden to locate and relieve the kinked portion of the hose.

There have been previous attempts to make hoses more resistant to kink, collapse, crush, and/or burst by incorporating a spiral or helical reinforcement strip into the outer tubular layer of the hose. This construction, however, has often made these reinforced hoses unduly stiff because the embedded helix lacks the ability to flex freely. This construction in some cases has often required thicker and more rigid inner tubular layers. What is needed, therefore, is a spiral reinforced fluid conduit in which the spiral reinforcement is readily customizable to suit the different performance needs of its users.

### SUMMARY

A fluid conduit in one embodiment includes a flexible member having a tubular wall configured to convey a fluid, the tubular wall defining a central axis extending through the flexible member, and a circumferential structural member located adjacent to the tubular wall, the structural member disposed about the central axis so as to form a plurality of segments along the tubular wall, the segments being spaced apart relative to each other to define a gap therebetween, the gap sized to be closed by contact between adjacent segments upon a predetermined flexure of the flexible member.

A method of forming a fluid conduit in one embodiment includes forming a flexible member with a tubular wall, the tubular wall defining a central axis extending through the flexible member, and forming a circumferential structural member adjacent to the tubular wall, the structural member disposed about the central axis so as to form a plurality of segments along the tubular wall, the segments being spaced apart relative to each other to define a gap therebetween, the gap sized to be closed by contact between adjacent segments upon a predetermined flexure of the flexible member.

### BRIEF DESCRIPTION OF THE DRAWINGS

FIG. 1 is a section cut through a portion of a flexible fluid conduit having a structural layer formed in accordance with the present disclosure;

FIG. 2 is a perspective view of the structural layer of FIG. 1;

FIG. 3 is a side plan view of the structural layer of FIG. 1;

FIG. 4 is an auxiliary view of a one-half revolution of a strip forming the structural layer;

FIG. 5 is a section cut through the strip of FIG. 4 along line A-A;

FIGS. 6-8 are section cuts through three embodiments of a conduit having the structural layer of FIG. 1 positioned differently in each embodiment;

FIGS. 9-12 are front plan views illustrating alternative methods to alter an intermediate layer of the conduit for integration with the structural member;

FIGS. 13-17 are section cuts through the conduit of FIG. 1 depicting the interaction between adjacent segments of the structural layer when the conduit is bent;

FIGS. 18-22 are section cuts through the conduit of FIG. 1 illustrating how dimensional changes to the features of the structural layer impact the flexibility of the conduit when the conduit of is bent along its central axis;

FIGS. 23-24 are section cuts through the conduit of FIG. 1 illustrating how the flexibility and compressibility of the intermediate layers and the segments of the structural layer effect the flexibility of the conduit;

FIG. 26 is a section cut through a portion of the conduit of FIG. 8 having a structural layer configured to move relative to the intermediate layers; and

FIGS. 27-28 are section cuts through a portion of the conduit having a portion of an intermediate layer embedded between the segments of the structural layer.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one skilled in the art to which this disclosure pertains.

FIG. 1 shows a straight portion of flexible fluid conduit 100 sectioned along its central axis 102. The conduit 100 includes an outer liner 106 and inner liner 104 that forms a flow path through the conduit 100. In the embodiment shown, the conduit 100 further includes a structural layer 108 positioned between the inner and outer liners 104, 106. The structural layer 108, as discussed in more detail below, is configured to prevent the restriction of fluid flow along the flow path due to bending or kinking of the conduit 100.

As best shown in FIGS. 2 and 3, the structural layer 108 is embodied as a strip of semi-flexible material that is positioned helically about the central axis 102. For purposes of this disclosure, the central axis 102 of the structural layer 108 and the central axis 102 of the conduit 100 are coincident, and any further reference to “central axis” refers to both axes. Each revolution of the strip has a gap 109 formed therebetween. In other embodiments, the gap 109 is vacuum or air filled. The consecutive gaps along the length of the structural layer 108 enable the structural layer 108 to flex and to extend and compress axially.

In some embodiments, the structural layer 108 is formed by wrapping the strip around a form. In other embodiments, the structural layer 108 is formed by extruding a tube and then spiral shaping the tube to form helical grooves about the central axis 102. The spiral cut in some embodiments is made entirely through the wall of the tube and in other embodiments is made partially through the wall of the tube.

When viewed along the section depicted in FIG. 1, the spacing between each helical revolution of the strip forms a series of spaced segments 110 above the central axis 102 and a series of spaced segments 110 below the central axis 102. As discussed in more detail below, it is the interaction between the spaced adjacent segments in the series of segments 110 that enables the structural layer 108 to prevent restrictions in the flow path when the conduit 100 is subjected to a collapsing or bending force.

FIG. 4 depicts an auxiliary view of a one-half revolution 112 of the strip when the strip is viewed from the arrow 114 of FIG. 3. FIG. 5 shows a cross section of the one-half revolution of the strip of FIG. 4 taken along line A-A with the section line oriented perpendicular to the helical path of the strip. In the embodiment shown, the strip has a rectangular cross section with a constant width W and a constant height H. In other embodiments, however, the width W and the height H of the cross section can vary over the length of the structural layer 108.

FIGS. 6-8 show three embodiments 116, 117, 118 of a conduit with the structural layer 108 at a different position on the conduit in each embodiment. The conduit of each of the embodiments includes an inner liner 104, a woven sleeve 120, a foamed liner 122, and an outer liner 106 each radially positioned from inside to outside about the central axis 102. In the embodiments shown, the woven sleeve 120 is depicted as a one-dimensional line between adjacent conduit layers. The structural layer 108 in each embodiment is at a different position within the conduit. For example, FIG. 6 shows the structural layer 108 positioned on the exterior of the conduit 116 adjacent to the outer liner 106. FIG. 7 shows the structural layer 108 of the conduit 117 positioned between the foamed liner 122 and the outer liner 106. FIG. 8 shows the structural layer 108 positioned within the interior of the conduit 118 adjacent to the flow path on the inside and the inner liner 104 on the outside. The embodiments of FIGS. 6-8 show the conduit as comprising five layers with the structural layer 108 positioned at three different locations within these layers. In other embodiments, the conduit can include lesser or greater numbers of layers with the structural layer 108 positioned between any of the provided layers.

The structural layer 108 in some embodiments is free to move or float rotationally around and/or axially along the central axis 102 of the conduit regardless of its position within the conduit. In other embodiments, the structural layer 108 is bonded to one or more adjacent layers of the conduit to restrict its relative movement about or along the central axis 102. The bonding of the structural layer 108 in these embodiments can be accomplished by any practical method. In one embodiment, an adhesive is used to secure the structural layer 108 to one or more of the adjacent conduit layers.

In some embodiments in which movement of the structural layer 108 is at least partially restricted, the structural layer 108 and at least one adjacent layer are integrated into a single layer. The integration of the structural layer 108 and the at least one adjacent layer can be accomplished as part of the extrusion process that forms the adjacent layer or by altering the adjacent layer after the extrusion process.

FIGS. 9-12 schematically illustrate methods to alter an adjacent layer 124 for integration with the structural layer 108. FIG. 9, for example, depicts the use of a tool 125 to press form or cut a helical groove 126 about the extruded adjacent layer 124 while the layer 124 is still soft. In some embodiments, the tool 125 is a forming tool rotated about the adjacent layer 124 in the direction of arrow 127 to form the helical groove 126 for the structural layer 108. In other embodiments, the forming tool 125 is fixed and the adjacent layer 124 is rotated in the direction of arrow 128 to form the groove 126. In other embodiments, the tool 125 of FIG. 9 is a rotating cutting tool used to mechanically remove material from the adjacent layer 124 to form the groove 126. In other embodiments, the tool 125 of FIG. 9 is a rolling tool used on the adjacent layer 124 to relieve or remove material from the adjacent layer 124, depending on the application, to create the void 126.

In some embodiments, such as the embodiment shown in FIG. 10, a fixed cutting tool 129 is used and the adjacent layer 124 is rotated about the fixed cutting tool 129 to form the structure 126. The tool can be, for example, a rotating padding tool, a blade or scribing tool (FIG. 10), or the like, or any combination thereof. FIG. 11 depicts the use of a tool 130, such as a laser, to thermally remove material from the adjacent layer 124 to form the groove 126. In other embodiments, the use of the laser 130 can modify a portion of the material from the adjacent layer 124 to release the structural layer 108. In some embodiments, the tool 130 forms the helical groove 128 by a non-thermal, non-contact method. The tool 130 in these embodiments directs an effect such as a frequency pulse, air wave, ripple effects or the like at the adjacent layer 124 to form the void or groove 126. FIG. 12 illustrates the use of a forming feature 131 protruding from the ring portion 132 of an extrusion device 133 to form the groove 126. In this embodiment, as the adjacent layer 124 is moved through the extrusion device 133, the ring portion 132 rotates about the adjacent layer 124 and the forming feature 131 forms the helical groove 126. Although specific tools and methods have been described with reference to FIGS. 9-12, any tool or method can be used to form the groove 126 in the adjacent layer during or after extrusion.

FIGS. 13-17 schematically depict the interaction between adjacent segments 110 of the structural layer 108 when the conduit 100 of FIG. 1 is bent along its central axis 102. FIG. 13 shows the conduit 100 of FIG. 1 having a downward bend along its central axis 102. In the embodiment of FIG. 13, the downward bend of the conduit 100 produces an outer bend 134 along the conduit 100 above the central axis 102 and an inner bend 136 along the conduit 100 below the central axis 102.

For purposes of this disclosure, the relative directions “down”, “downward”, or “downwardly” refer to a direction pointing toward the bottom of the drawing sheet and the relative directions “up”, “upward”, or “upwardly” refer to a direction pointing toward the top of the drawing sheet. Similarly, the terms “bottom” or “below” refer to relative positions closer to the bottom of the drawing sheet and the terms “top” or “above” refer to relative positions closer to the top of the drawing sheet.

The following subscripts are used in conjunction with the letter X to denote the various segment-to-segment gap distances shown in the figures: (s)=straight conduit, (d)=downward bent conduit, (o)=outer bend position, (i)=inner bend position, (t)=tip gap between adjacent segments, and (b)=base gap between adjacent segments. For example, the gap distance X_{dot} refers to the gap measured on a downward bent conduit (the subscript “d”) at the outer bend position (the subscript “o”) at the tip of the segments (the subscript “t”).

FIG. 14 shows two adjacent segments 110 positioned above the inner liner 104 at the approximate position of the outer bend 134 before the conduit 100 is bent. In the straight conduit of FIG. 14, the facing sides 138 of the adjacent segments 110 are parallel with respect to each other. Accordingly, the gap between the segments 110 at the base of the segments 110 or the base gap X_{sob} and the gap between the segments 110 at the tip of the segments 110 or the tip gap Xₛₒₜ are equal. In other words, the base gap X_{sob} and the tip gap Xₛₒₜ can be collectively referred to as the straight gap Xₛₒ of the straight conduit at the position of the outer bend 134. When the conduit 100 is bent downward at the outer bend 134 as depicted in FIGS. 13 and 15, the base gap of the bent conduit X_{dob} is approximately equal to or greater than the straight gap of the straight conduit Xₛₒ. The tip gap of the bent conduit X_{dot}, however, is typically greater than the straight gap of the straight conduit Xₛₒ since the adjacent segments 110 rotate away from each other as the inner liner 104 bends downward.

FIG. 16 shows two adjacent segments 110 positioned below the inner liner 104 at the approximate position of the inner bend 136 before the conduit 100 is bent. In the straight conduit of FIG. 16, the facing sides of the adjacent segments 110 are parallel with respect to each other. Accordingly, the gap between the segments 110 at the base of the segments 110 X_{sib} and the gap between the segments 110 at the tip of the segments Xₛᵢₜ are equal. In other words, the base gap X_{sib} and the tip gap Xₛᵢₜ can be collectively referred to as the straight gap Xₛᵢ of the straight conduit at the position of the inner bend 136.

When the conduit 100 is bent downward at the inner bend 136 as depicted in FIGS. 13 and 17, the base gap of the bent conduit X_{dib} is approximately equal to or less than the straight gap of the straight conduit Xₛᵢ. The tip gap of the bent conduit X_{dit}, however, can range from slightly less than the straight gap of the straight conduit Xₛᵢ to zero. In other words, after a predefined amount of bending, the tips of the segments 110 at the inner bend 136 contact each other and provide a positive stop to prevent further bending of the conduit 100 at positions adjacent to the contacting segments 110. The segment-to-segment contact between each of the adjacent segments in the series of segments 110 prevents the conduit 100 from collapsing into the flow path and substantially restricting the fluid flow therethrough.

FIG. 18 shows two adjacent segments 110 positioned above the inner liner 104 at an inner bend 136 of the conduit 100 after the conduit 100 of FIG. 1 has been bent upwardly (not shown). The adjacent segments 110 have a height H, a width W, a base gap X, and form a contact angle A having its vertex at the contact point of the segments 110. The maximum contact angle A formed between each of the adjacent segments in the series of segments 110 is one of a number of factors that determines the relative amount of bend of the conduit 100 over its length.

As shown by comparing FIGS. 18 and 19, reducing the base gap between the adjacent segments 110 from X to X′ while holding constant the height H_{c} and the width W_{c} of the segments 110 reduces the contact angle from A to A′ and, therefore, reduces the overall amount of bend in the conduit 100. The contact angle A′ is reduced because the reduction in the base gap between the adjacent segments 110 moves the effective pivot points of the segments 110 closer together as the conduit 100 bends in the upward direction. Accordingly, the segments 110 rotate less before the tips of the segments 110 contact each other. If the base gap X between the adjacent segments 110 of FIG. 19 is increased, the contact angle A similarly increases, allowing more overall bend in the conduit 100 before the tips of the segments 110 contact each other.

As shown by comparing FIGS. 18 and FIG. 20, reducing the height of the adjacent segments 110 from H to H′ while holding constant the base gap X_{c} between the segments 110 and the width W_{c} of the segments 110 increases the contact angle from A to A″ and, therefore, increases the overall amount of bend in the conduit 100. The contact angle A″ is increased because the reduction in the height of the adjacent segments 110 allows the segments 110 to rotate further about their effective pivot points before the tips of the segments 110 contact each other. If the height H of the adjacent segments 110 of FIG. 20 is increased, the contact angle A decreases, allowing less overall bend in the conduit 100 before the tips of the segments 110 contact each other.

As explained with reference to FIGS. 21 and 22, reducing the width of each of the segments 110 from W (FIG. 21) to W′ (FIG. 22) while holding constant the base gap X_{c} between the segments 110 and the height H_{c} of the segments 110 results in more flex regions 140 between the segments 110 for the same overall length of conduit 100. Increasing the number of flex regions along the length of the conduit increases the overall flexibility of the conduit because the cumulative length of the conduit capable of flexing increases with each added flex region.

As shown in FIGS. 23 and 24, a reduction in the flexibility of the liner 104 can reduce the overall flexibility of the conduit 100. In a straight conduit, the base gaps between the segments 110 in each of FIGS. 23 and 24 are equal. The highly flexible inner liner 104 of FIG. 23 allows the maximum distance between the effective pivot points of the segments 110 in the bent conduit. In contrast, the more rigid inner liner 104′ of FIG. 24 reduces the distance between the effective pivot points in the segments 110 in the bent conduit. In particular, a line 142 connecting the effective pivot points of the segments 110 of FIG. 23 falls along the path of the inner liner 104, indicating that the line 142 represents the maximum distance between the effective pivots points. In contrast, a line 144 connecting the effective pivot points of the segments 110 of FIG. 24 does not fall along the path of the inner liner 104′ due to the reduced flexibility of the inner liner 104′.

FIG. 25 illustrates the effect that the compressibility of the strip material has on the contact angle between the adjacent segments 110. In the embodiment shown, the strip material at the contact point 146 between the two adjacent segments 110 is slightly deformed due to the compression of the material. For purposes of this disclosure, the term “non-deformed contact angle” refers to the angle formed when adjacent segments first make contact at the contact angle 146, but before either of the segments begins to deform. The term “fully-deformed contact angle” refers to the angle formed after adjacent segments have made contact at the contact point 146 and after both of the segments are fully deformed. As the segments 110 become more compressible, especially at their tip, the difference between the non-deformed contact angle and the fully-deformed contact angle increases between the adjacent segments 110, resulting in more overall flexibility in the conduit. The converse is also true. That is, as the segments 110 become less compressible, the difference between the non-deformed contact angle and the fully-deformed contact angle decreases between the adjacent segments 110, resulting in reduced overall flexibility in the conduit.

Although the structural layer 108 has been primarily depicted in the figures as bonded to or integrated with one or more of the layers of the conduit 100, the structural layer 108 can also be provided as a free floating structural layer 208 over the exterior or within the interior of the conduit. For example, FIG. 26 shows a section of the conduit 118 of FIG. 8 taken along its central axis 102. In this embodiment, the conduit 118′ is bent downwardly along its central axis 102. The structural layer 208 is positioned radially inside the inner liner 104 and, because the structural layer 208 is not bonded to the inner liner 104, it is free to move or float relative to the inner liner 104. The segments 210 of the free floating structural layer 208 prevent flow path restriction in a manner similar to that of the segments 110 of the bonded structural layer 108, but the segments 210 provide the conduit 118′ with a greater range of bending motion.

FIGS. 27 and 28 illustrate the effect that integration of the structural layer 108 with another layer has on the flexibility of the conduit 100. FIG. 27 depicts two adjacent segments 110 in a straight section of the conduit 100. The segments 110 are adjacent to the inner liner 104 and integrated with the outer liner 206. The gap between the adjacent segments 110 is occupied by the material of the outer liner 206. FIG. 28 shows the two adjacent segments 110 after the conduit 100 of FIG. 27 has been upwardly bent. In this embodiment, as the segments 110 come together due to the bending of the conduit 100, the portion 210 of the outer liner 206 between the segments 110 is compressed. The density of the outer liner material, therefore, determines how close the segments 110 can get to each other. Bending of the conduit 100 in the opposite direction causes the outer liner material to stretch between the segments 110.

The spiral reinforced fluid conduit of the present disclosure is suitable for automotive, household, commercial, aerospace, medical, and industrial uses. The plurality of spiral or helical reinforcement members enable the structural layer to flex and to extend and compress axially.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A fluid conduit, comprising:
a flexible member having a tubular wall configured to convey a fluid, the tubular wall defining a central axis extending through the flexible member; and
a circumferential structural member located adjacent to the tubular wall, the structural member disposed about the central axis so as to form a plurality of segments along the tubular wall, the segments being spaced apart relative to each other to define a gap therebetween, the gap sized to be closed by contact between adjacent segments upon a predetermined flexure of the flexible member.

2. The fluid conduit of claim 1, wherein the structural member is bonded to the tubular wall.

3. The fluid conduit of claim 1, wherein the structural member moves freely relative to the tubular wall.

4. The fluid conduit of claim 1, wherein the structural member is integrally formed on the tubular wall, the segments of the structural member being defined by a helical groove formed about the central axis in a portion of the tubular wall.

5. The fluid conduit of claim 4, wherein each of the segments has a base portion located adjacent to the tubular wall and a tip portion spaced radially from the tubular wall, and wherein the flexure of the flexible member is limited by contact between the tip portions of the adjacent segments.

6. The fluid conduit of claim 5, wherein the flexure of the flexible member is adjustable by varying one or more of:
a radial thickness of the segments as measured from the base portion to the tip portion;
an axial gap between the segments as measured between the respective base portions of the segments; and
an axial width of the segments as measured across a cross section of the segments along a plane defined by the central axis and a radial line extending from the central axis.

7. The fluid conduit of claim 5, wherein the flexible member is formed from a compressible material, and wherein the flexure of the flexible member is adjustable by varying the compressibility of the material at the tip portions of the segments.

8. The fluid conduit of claim 1, wherein the structural member is located adjacent to an inner surface of the tubular wall.

9. The fluid conduit of claim 1, wherein the structural member is located adjacent to an outer surface of the tubular wall, the fluid conduit further comprising a second flexible member formed on the outer surface of the tubular wall, the second flexible member encapsulating the segments and formed of a compressible material.

10. The fluid conduit of claim 9, wherein the flexure of the flexible member is further limited by compression of the compressible material positioned between the adjacent segments.

11. A method of forming a fluid conduit, comprising:
forming a flexible member with a tubular wall, the tubular wall defining a central axis extending through the flexible member; and
forming a circumferential structural member adjacent to the tubular wall, the structural member disposed about the central axis so as to form a plurality of segments along the tubular wall, the segments being spaced apart relative to each other to define a gap therebetween, the gap sized to be closed by contact between adjacent segments upon a predetermined flexure of the flexible member.

12. The method of claim 11, wherein forming a structural member adjacent to the tubular wall comprises:
forming a helical groove about the central axis in a portion of the tubular wall so as to define the plurality of segments therein.

13. The method claim 12, wherein forming a helical groove comprises:
moving a cutting tool relative to the tubular wall to remove material from the tubular wall; or
moving the tubular wall relative to the cutting tool to remove the material from the tubular wall.

14. The method of claim 13, wherein the cutting tool is configured as one or more of a fixed cutting tool and a rotating cutting tool.

15. The method of claim 12, wherein forming a helical groove comprises:
moving a rotating wheel relative to the tubular wall to compress material of tubular wall;
moving the tubular wall relative to the rotating wheel to compress the material of the tubular wall; or
moving a protrusion relative to the tubular wall to compress the material of the tubular wall, the protrusion being affixed to a rotating component of an extrusion device.

16. The method of claim 15, wherein the tubular wall is formed from a material having a pliable first state and a hardened second state, and wherein the material is compressed to form the groove while the material is in the pliable first state.

17. The method of claim 12, wherein forming a helical groove comprises:
irradiating the tubular wall with a laser to remove material from the tubular wall while one of moving the laser relative to the tubular wall or moving the tubular wall relative to the laser.

18. The method of claim 12, wherein forming a helical groove comprises:
propelling a material from a tool to remove material from the tubular wall while one of moving the tool relative to the tubular wall or moving the tubular wall relative to the tool.

19. The method of claim 18, wherein the tool is configured to propel one or more of compressed air, water, and aggregate towards the tubular wall to remove the material therefrom.

20. The method of claim 12, where forming a structural member comprises:
helically wrapping a strip of semi-flexible material around a form; and
bonding the formed strip to the tubular wall.
